(19) United States
(12) Patent Application Publication
(10) Pub. No.: US 2003/0081008 A1
(43) Pub. Date: May 1, 2003

(54) Method and apparatus for controlling an electronic device via a menu displayed on a display screen of the electronic device

(76) Inventor: Byung-Ryul Seo, Yongin-City (KR)

Correspondence Address: Joseph J. Buczynski, Roylance, Abrams, Berdo & Goodman, L.L.P., Suite 600, 1300 19th Street, N.W., Washington, DC, 20036, US

(21) Appl. No.: 10/232,699

(22) Filed: Sep. 3, 2002

(30) Foreign Application Priority Data
Oct. 29, 2001 (KR) 2001-66850

(51) Int. Cl. G09G 5/00

(52) U.S. Cl. 345/810

(57) ABSTRACT

A method for controlling an electronic device using on-screen display menus which display a plurality of functions of the electronic device. The menus are displayed in a tree structure based on the functions of the device. The menu representing the upper directory of functions is displayed when the function selection process is started. A menu of the lower directory of items relating to the item in the upper directory of functions is displayed when a cursor is placed on or proximate to that item in the upper directory to select that item. The cursor can then be used to select an item in the menu of the lower directory to select that item to change the status of the function which that item represents. At least a portion of the upper directory menu and a portion of the lower directory menu are displayed concurrently on the display screen. Thus, the user can check all functions on one screen while also being able to ascertain which functions are being performed by the device. Moreover, the user can easily change the status of any of the functions through the user of the cursor.

This application claims benefit under 35 U.S.C. §119 from Korean Patent Application No. 2001-66850, filed on Oct. 29, 2001, the entire content of which is incorporated herein by reference.

### BACKGROUND OF THE INVENTION

1. Field of the Invention

The present invention relates to an apparatus and method for controlling an electronic device using a menu displayed on the display screen of the electronic device. More particularly, the present invention relates to an apparatus and method for controlling an electronic device having an OSD (on-screen display) apparatus that enables a user to easily change function set-up by displaying various functions of the electronic device in an on-screen display menu and using the menu to change the status of the various functions.

2. Description of the Related Art

Generally, when electronic devices are being operated and the operation of the device is to be changed, a user has to select the function to be changed and adjust the status of that function as desired to thus change the operation and control of the device. Therefore, conventional electronic devices typically have a control panel that a user can access to control the electronic devices. The control panel will generally have one or more key inputs that enable the user to input commands by manipulating the key inputs. Also, a conventional electronic device may have a display window so that the user can confirm the operation status and the control status of the device by viewing items on the display window representing the operation and control status of the device.

Because the sizes of recent electronic devices have become smaller and compactness of design is considered more important than ever before, the number of buttons or key inputs for a device should be reduced. In particular, conventional electronic devices having many functions have numerous buttons for operation and control of the functions. It is therefore desirable to eliminate as many buttons as possible while still maintaining the capability of controlling and changing the functions of the device as desired. However, due to this need to reduce the number of buttons, problems relating to the design of the electronic devices, as well as to production cost, can arise, and the overall structure of the devices can become more complicated. In an attempt to avoid these problems, the devices can employ onscreen display (OSD) functionality so that an OSD menu replaces the buttons.

FIGS. 1 and 2 are views showing a display unit 10 of a video camcorder employing a function set-up technique using a conventional OSD menu. As shown in FIG. 1, a menu 12 for setting or changing a function of the conventional electronic device displays a menu list which divides operable functions instead of grouping the menu 12 based on the function. Therefore, when the user places a cursor 15 on an item representing a desired function of the video camcorder by moving the cursor 15 on the display screen, and then inputs an enter signal, the function is turned on or off, or, if the function has several function options, the screen is changed to display a lower menu, which is commonly referred to as a “drop down menu” relating to the item of the menu 12 on which the cursor 15 is placed. In this example, the reference numeral 11 is a menu function mode, item 13 is a menu item on which the cursor 15 is placed, item 14 is a function icon, and item 16 is a status indicator that indicates whether a particular function is on, off or in an automatic mode.

As shown in FIG. 2, the menu 12 is displayed for each level. That is, when the upper menu is displayed on an initial screen as shown in FIG. 1, the function to be changed is selected among the upper menu as described above, and the status of the function can be changed via the lower menu as shown in FIG. 2.

In other words, according to the conventional technique, only a menu list that is available for each menu is displayed, and the structure of each menu is different. Therefore, the user cannot check all functions of the device on a single display screen, especially when the functions are not divided into groups. Hence, it is difficult to confirm the modes in which the functions are operating. Moreover, as shown in FIG. 2, even though the functions are divided into groups, the upper and lower menus of a corresponding function are not displayed. Thus, it is difficult to check the upper menu identifying the general function when setting up a final function in the lower menu.

### SUMMARY OF THE INVENTION

The embodiments of the present invention described herein overcome the above-mentioned problem associated with the conventional devices. Accordingly, it is the object of the present invention to provide an apparatus and method for controlling an electronic device having an OSD (on-screen display) apparatus that enables a user to easily change function set-up by displaying various functions of the electronic device in an on-screen display menu and using the menu to change the status of the various functions.

The apparatus and method perform the operations of displaying a first menu of a directory of functions of the device and a cursor on the on the display screen, moving the cursor to select an item among those in the first menu displayed in accordance with a cursor movement signal, and displaying on the display screen a second menu relating to the item of the first menu that the cursor selects when a selection signal is input. The method and apparatus further perform the operations of moving the cursor to select an item among the second menu, and changing a function of the electronic device represented by the item in the second menu that the selected.

The display screen displays the menus such that at least a portion of the first menu and at least a portion of the second menu are displayed concurrently on the display screen when the cursor is moved to select an item in the first menu. In particular, each item of the second menu can be displayed initially on one side of the first menu. The display screen also can display respective folder icons proximate to each item in the first menu, and change an appearance of the folder icon relating to the selected item in the first menu after that item is selected. The display screen can further display a respective function status indication pertaining to each item in the second menu, as well as a respective symbol pertaining to an item in the second menu whose function is fixed. A warning message can be displayed when the cursor attempts to select the item in the second menu whose function is fixed. In particular, the warning message can be displayed on alone on the display screen for a period of time, after which the first and second menus can be redisplayed.

### BRIEF DESCRIPTION OF THE DRAWINGS

The above-mentioned objects and the feature of the present invention will be more apparent by describing the preferred embodiment of the present invention by referring to the appended drawings, in which:

FIGS. 1 and 2 are views showing screens of a conventional display unit which display the status of function set-up of an electronic apparatus;

FIGS. 3 through 8 are views showing examples of screens of a display unit which display the status of functions of an electronic apparatus and enable a user to conveniently change the status of those functions as desired according to an embodiment of the present invention; and

FIG. 9 is a flow chart showing an example of steps of a menu controlling method according to an embodiment of the present invention.

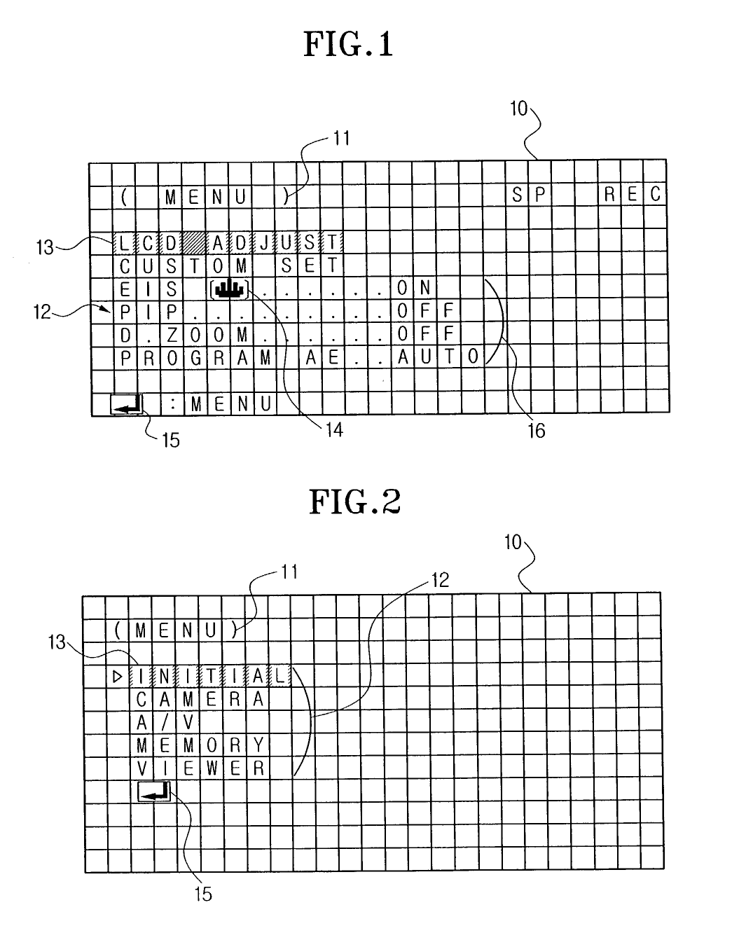

### DETAILED DESCRIPTION OF THE PREFERRED EMBODIMENT

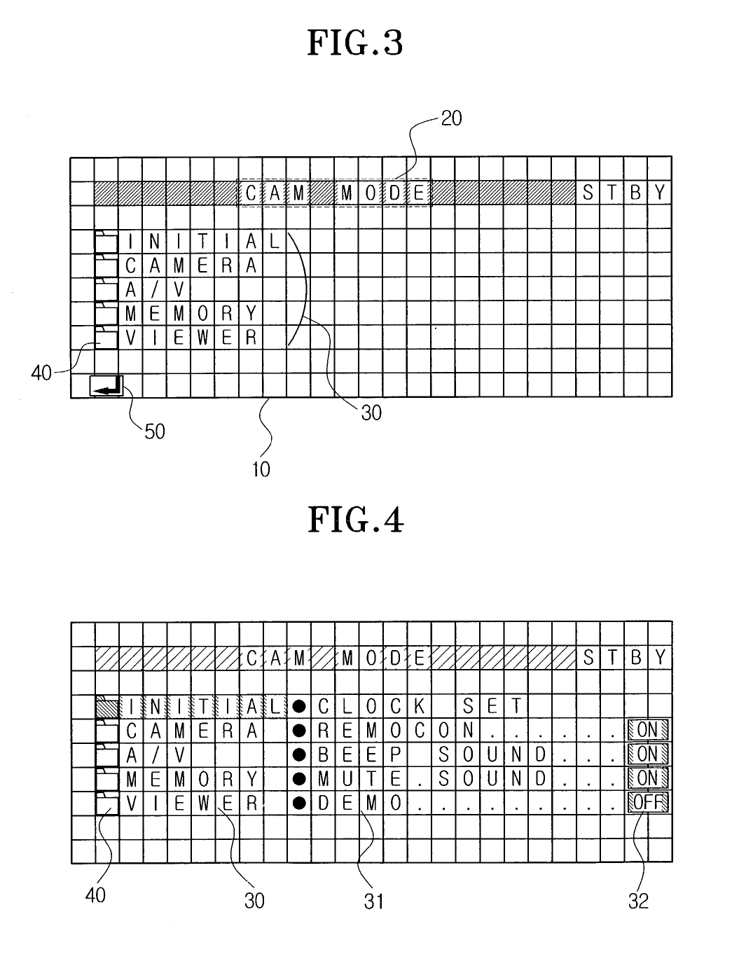

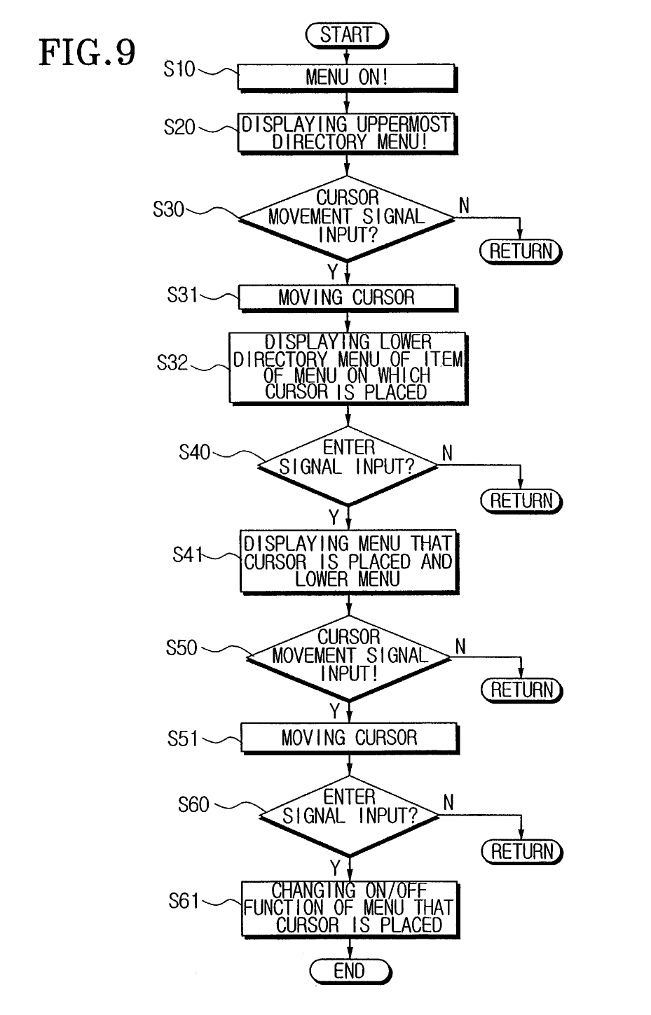

An embodiment of the present invention will now be described with reference to FIGS. 3-9. FIG. 9 is a flow chart showing an example of steps of a menu controlling method according to an embodiment of the present invention, and FIGS. 3 through 8 are views showing an example of display screens displayed on a display unit of a video camcorder when the steps of the menu controlling method shown in FIG. 9 are being performed.

As shown in FIG. 9, when the function of a menu is started, an embodiment of the present invention performs steps S10 and S20 of displaying an uppermost directory menu list and a cursor on a display screen. Steps S30 and S31 of moving the cursor to a menu item of a menu list displayed based on a signal when a cursor movement signal is input are performed, followed by step S32 of displaying the menu item on which the cursor is placed and a lower directory menu relating to that menu item together on the display screen. The method then performs steps S40 and S41 of displaying an upper menu including the menu item on which the cursor is placed and a lower menu list corresponding to the menu item on which the cursor is placed in the upper menu when an enter signal is input after step S32 has been performed. Steps S50 and S51 are performed for moving the cursor to a corresponding menu among the lower menu list based on the cursor movement signal when the cursor movement signal is input after step S41 has been performed. Then, steps S60 and S61 are performed for changing the status of the item of the lower menu list on which the cursor has been placed when the enter signal is input after step S51 has been performed.

FIG. 3 is a view showing an example of an initial screen on which a menu is displayed for changing a status of a function of the device, such as a video camcorder. When the user turns on the menu to set up or change a function, a menu list 30 corresponding to the uppermost directory is displayed on the display unit 10 as illustrated. The display unit 10 for displaying the function or the operation status of the electronic device can be an LCD disposed in a control panel (not shown), or a screen to display a compound video signal as is done by a TV or a VTR. Moreover, if the device is a video camcorder, a viewfinder which displays a photographed image can be the display unit 10, and the menu list can be displayed with the photographed image on the viewfinder. The movement signal that controls movement of the cursor 50 can be input by the user by using a dial button or a tack button. Displaying of the menu list 30 can be controlled by separately disposing a menu on/off button (not shown) on the device. In the menu selection step, an operation mode 20 can also be displayed on the display screen. For example, FIG. 3 shows that the video camcorder is operating in a camera mode 20. The uppermost directory menu list 30 can further display an indication as to whether a particular menu item has been selected by displaying a folder icon 40. Moreover, the cursor 50 is displayed together with the set up mode 20, menu list 30 and folder icons 40. Therefore, the user can move the cursor 50 to a desired item on the menu list 30 by manipulating a cursor movement switch (not shown).

FIG. 4 is a view showing the display unit 10 in the status that the cursor 50 is moved by selecting an initial set-up menu from the uppermost directory menu list 30 by manipulating the cursor movement switch. The cursor 50 can be displayed by changing the color of the background of the item in the uppermost directory menu list 30 that the cursor 50 is placed on or proximate to. When the cursor 50 is placed on or proximate to a particular item on the menu list 30 (in this example, the “initial” menu item), a lower menu list 31 relating to that item on the uppermost directory menu list 30 is displayed together with the menu list 30. In this example, the lower menu list 31 includes the functions “CLOCK SET”, “REMOCON”, “BEEP SOUND”, “MUTE SOUND” and “DEMO”. The function set-up status of the lower menu 31 can be displayed by using on/off icons 32. The cursor can be moved to the lower menu, and when the enter signal is input by manipulating a function change switch (not shown), then the status of the function in the lower menu that the cursor has been placed on or proximate to can be changed, for example, to an on status or an off status.

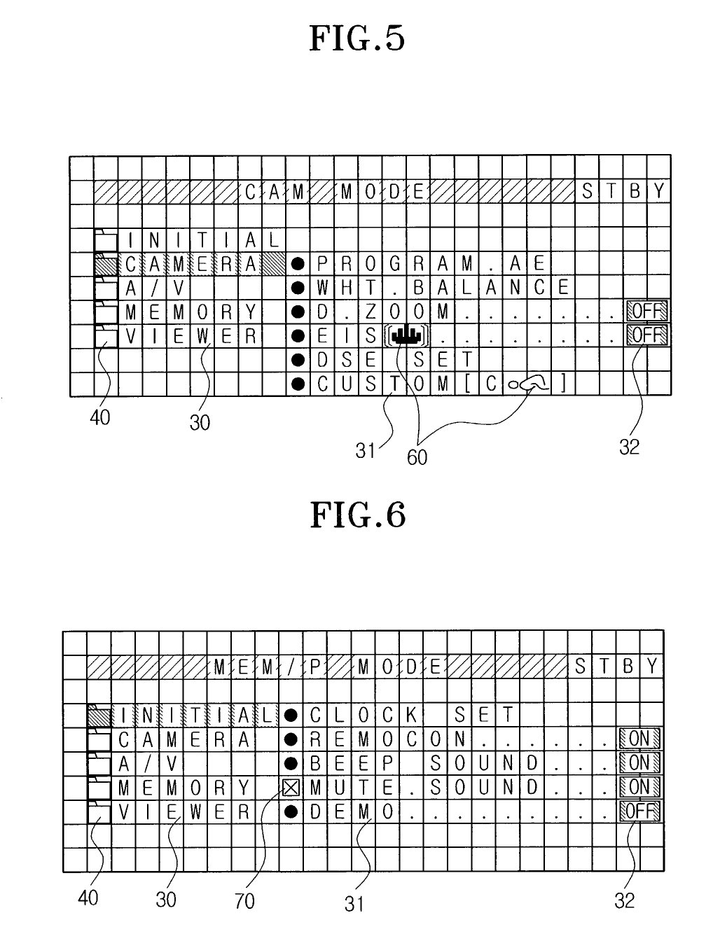

FIG. 5 is a view showing the display unit 10 when the cursor 50 is moved to the camera menu item in the menu list 30. As shown in FIG. 5, a respective function icon 60 which further represents a respective function in the lower menu list 31 can be displayed on one side of the menu list 31. In this example, the lower menu list 31 includes the functions “PROGRAM AE”, “WHT. BALANCE”, “D. ZOOM”, “EIS”, “DSE SET” and “CUSTOM”. In this example, icons are displayed next to the “EIS” and “CUSTOM” functions as shown.

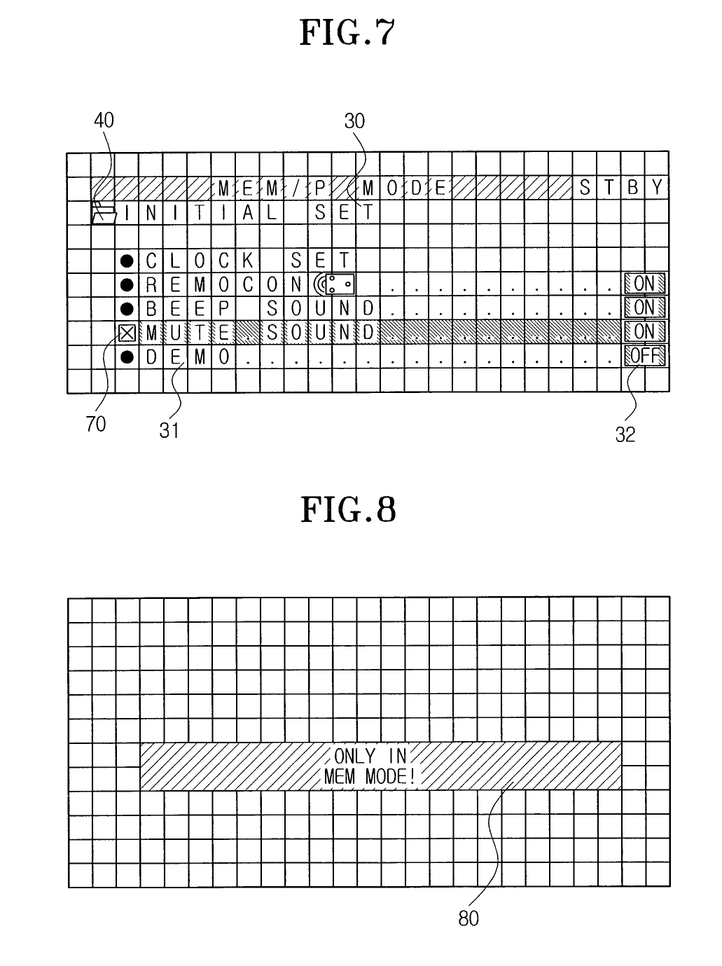

In the case of a video camcorder, there are several modes such as a camera mode, a record mode, a play mode and a VCR mode, and there might be a menu that does not correspond to a particular mode. FIGS. 6 and 7 are views showing a menu in a play mode (MEM/P MODE). In the play mode, an on or off state of the mute sound function cannot be changed from the initial menu. In this case, a mark 70 indicating that the set-up condition for this function cannot be changed can be displayed on one side of the corresponding menu item as shown in FIGS. 6 and 7.

As discussed above, when the enter signal is input after the cursor 50 is placed on a particular item in the uppermost directory menu list 30, only the item in the uppermost directory menu list 30 that the cursor 50 is placed on or proximate to and a corresponding lower menu 31 list are displayed as shown in FIG. 7. FIG. 7 shows the display unit 10 when the enter signal is input after moving the cursor 50 to the initial set-up menu in the play mode. At this time, the folder icon 40 next to the “INITIAL” function in the uppermost directory menu list 30, which is shown as highlighted and closed in FIG. 6, is displayed as being changed to open status, and the lower menu list 31 is displayed under the “INITIAL SET” function. As shown in FIG. 7, the function set-up of the mute sound cannot be changed in the play mode, thus the mark 70 indicating that the status of this item cannot be changed is displayed on one side of the mute sound menu item. When the cursor is placed on a fixed menu item, such as the mute sound menu item, and the enter signal is input to change the set-up status, the other items in the OSD are turned off and a warning mark is displayed for a predetermined period as shown in FIG. 8. After the predetermined period has elapsed, the original screen is displayed as shown in FIG. 7.

In accordance with the disclosed embodiments of the present invention, when the menu is started, the uppermost item in the directory menu list 30 among the menu that has been set up as a tree structure for function is displayed, and the uppermost directory menu 30 and the lower menu list 31 are displayed together as controlled by the cursor as discussed above. As described above, the user can check all functions on one screen because the upper menu list 30 and the corresponding lower menu 31 are displayed together. Moreover, the user can check the states of the functions listed in the lower menu 31. In addition, the user can change the status of a function in the corresponding menu 31 by inputting the enter signal when the cursor 50 is placed on or proximate to the desired function in the corresponding menu 31. The enter signal can be input by manipulating a separately disposed button, or a voice recognition device can be disposed to allow the user to input the enter signal with his or her voice without separate manipulation.

According to the embodiments of the present invention described above, because the lower menu lists are set up as directory based on the respective functions in the upper menu list and all functions are displayed as a tree structure by the OSD, the user can check a corresponding upper and lower menu list and a function status mode at the same time. Furthermore, the user can check the function that the device is performing in an upper directory menu. Thus, it is very convenient for the user to view the available functions, and the user also can change the status of the functions very easily.

Although a preferred embodiment of the present invention has been described, it will be understood by those skilled in the art that the present invention should not be limited to the described preferred embodiment, but various changes and modifications can be made within the spirit and the scope of the present invention. Accordingly, the scope of the present invention is not limited within the described range but the following claims.

What is claimed is:

1. A method for controlling an electronic device having a display screen, the method comprising:
displaying a first menu of a directory of functions of the device and a cursor on the on the display screen;
moving the cursor to select an item among those in the first menu displayed in accordance with a cursor movement signal;
displaying on the display screen a second menu relating to the item of the first menu that the cursor selects when a selection signal is input;
moving the cursor to select an item among the second menu; and
changing a function of the electronic device represented by the item in the second menu that the selected.

2. The method of claim 1, wherein at least a portion of the first menu and at least a portion of the second menu are displayed concurrently on the display screen when the cursor is moved to select an item in the first menu.

3. The method of claim 1, further comprising displaying respective folder icons proximate to each item in the first menu.

4. The method of claim 3, further comprising changing an appearance of the folder icon relating to the selected item in the first menu after that item is selected.

5. The method of claim 1, wherein the step of displaying the second menu displays each item of the second menu on one side of the first menu on the display screen.

6. The method of claim 1, further comprising displaying a respective function status indication pertaining to each item in the second menu.

7 The method of claim 1, further comprising displaying a respective symbol pertaining to an item in the second menu whose function is fixed.

8. The method of claim 7, further comprising displaying a warning message when the cursor attempts to select the item in the second menu whose function is fixed.

9. The method of claim 8, wherein the warning message is displayed on the display screen for a period during which the display screen discontinues displaying any portion of the first and second menus.

10. The method of claim 9, further comprising redisplaying the second menu and at least a portion of the first menu after discontinuing to display the warning message after the period has elapsed.

11. An apparatus for controlling an electronic device having a display screen, the apparatus comprising:
a display screen, adapted to display a first menu of a directory of functions of the device and a cursor; and
a control device, adapted to move the cursor to select an item among those in the first menu displayed in accordance with a cursor movement signal;
the display screen being further adapted to display on the display screen a second menu relating to the item of the first menu that the cursor selects when a selection signal is input from the control device; and
the control device being further adapted to move the cursor to select an item among the second menu, and to change a function of the electronic device represented by the item in the second menu that the cursor selected.

12. The apparatus of claim 11, wherein at least a portion of the first menu and at least a portion of the second menu are displayed concurrently on the display screen when the cursor is moved to select an item in the first menu.

13. The apparatus of claim 11, wherein the display screen is further adapted to display respective folder icons proximate to each item in the first menu.

14. The apparatus of claim 13, wherein the display screen is further adapted to change an appearance of the folder icon relating to the selected item in the first menu after that item is selected.

15. The apparatus of claim 11, wherein the display screen is further adapted to display each item of the second menu on one side of the first menu on the display screen.

16. The apparatus of claim 11, wherein the display screen is further adapted to display a respective function status indication pertaining to each item in the second menu.

17 The apparatus of claim 11, wherein the display screen is further adapted to display a respective symbol pertaining to an item in the second menu whose function is fixed.

18. The apparatus of claim 17, wherein the display screen is further adapted to display a warning message when the cursor attempts to select the item in the second menu whose function is fixed.

19. The apparatus of claim 18, wherein the warning message is displayed on the display screen for a period during which the display screen discontinues displaying any portion of the first and second menus.

20. The apparatus of claim 19, wherein the display screen is further adapted to redisplay the second menu and at least a portion of the first menu after discontinuing to display the warning message after the period has elapsed.
